(19) United States
(12) Patent Application Publication
(10) Pub. No.: US 2011/0179026 A1
(43) Pub. Date: Jul. 21, 2011

(54) Related Concept Selection Using Semantic and Contextual Relationships

(76) Inventors: Erik Van Mulligen, Rotterdam (NL); Ravi Kalaputapu, Rockville, MD (US); Marc Weeber, Groningen (NL); Rajiv Salimath, Vienna, VA (US)

(21) Appl. No.: 13/010,672

(22) Filed: Jan. 20, 2011

Related U.S. Application Data
(60) Provisional application No. 61/297,121, filed on Jan. 21, 2010.

(51) Int. Cl. G06F 17/30

(52) U.S. Cl. 707/728; 707/769; 707/E17.014

(57) ABSTRACT

A system and method for ranking results derived from various analytical processes for a concept selector is disclosed. The method ranks the concepts extracted for information input to a concept selector by semantic mapping and contextual mapping techniques. Information is input to a concept selector. The concept selector may then analyze the input information to select list of matched synonyms, generate concept relationship maps, concept database maps for the matched concepts from its databases. In addition, content provided from the web page may also be analyzed by the concept selector for mapping the concepts. Further, obtained list of matched terms, keywords and concepts are sent to the ranking module for ranking the results. The ranking module may rank the results obtained based on pre-defined filtering techniques such as semantic rules, business rules and so on. The ranked results are output by the concept selector.

### CROSS REFERENCE TO RELATED APPLICATION

This application claims the benefit of U.S. Provisional Patent Application No. 61/297,121 filed on Jan. 21, 2010, the contents of which in its entirety is herein incorporated by reference.

### TECHNICAL FIELD

This invention relates to information retrieval and information extraction and, more particularly but not exclusively, to concept selection mechanism in the process of information retrieval and information extraction.

### BACKGROUND

Internet has become an increasingly accessible means to search content on the web. Web based content searching forms a large swath of today's Internet ecosystem. One of the main means for extraction of information is based on contextual analysis of the search query. Some mechanisms employ means for generation of keywords, synonyms and the like for obtaining search results. Also, some approaches employ relevance listing based on co-occurrence of the same words or synonyms for the word within the web page. However, such mechanisms for extracting search results based solely on words or phrases found within the text of the web page can lead to erroneous results.

In an example, in generating contextual information for an input query the search engines extract information from each and every web page of a website. Every bit of information extracted is indexed and stored in the database maintained by the search engine. A list of keywords is obtained and stored from the indexed information. When a user enters a search query, the search query is compared against the indexed information and a list of relevant search results is obtained. During the comparison process, the search query entered by the user is compared against list of keywords to obtain the results. In such mechanisms, a hard match is required between the query entered by the user with one of the keywords or key phrases stored in the database. Hence, website owners that submit their web page to such search service have to find the set of keywords that best fit the submitted web page. The same holds true when a user submits a search query with a spelling mistake, a partial query (which consists of a sub-string of the indexed key terms), and a query in which the words do not appear in the same order as is in the indexed key terms and so on. In all such cases, the search service may not provide the user with appropriate search results to the submitted query. As a result, such mechanisms are not effective in extracting effective results for search query input by the user.

Some other search systems employ a method wherein the query entered by the user is mapped to obtain closeness in the “meaning” for the search query. Further, information that is closest in “meaning” is returned in the search results. One significant drawback of this method is that obtaining “meaning” is relatively vague and not easily determined. These search engines provide limited functionality and also do not recognize keywords in the query that are beyond the exact matches produced by the matching process.

### SUMMARY

An object of the invention is to rank retrieved concepts, terms and keywords from various content analytic processes.

A further object of the invention is to employ information provided from sources such as synonym list, concept relationship maps, content page and terms for obtaining relevant concepts.

The embodiments herein disclose a method for ranking the results retrieved for information input to a concept selector. Referring now to the drawings, and more particularly to FIGS. 1 through 7, where similar reference characters denote corresponding features consistently throughout the figures, there are shown preferred embodiments.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, through out which like reference letters indicate corresponding parts in the various figures. The embodiments herein will be better understood from the following description with reference to the drawings, in which:

FIG. 1 is a flow chart depicting the process of extracting results for information input to a concept selector, according to embodiments as disclosed herein;

FIG. 2 illustrates a block diagram of a concept selector, according to embodiments as disclosed herein;

FIG. 3 is a flow chart depicting an analytic process for retrieving relevant results with terms as input to a concept selector, according to embodiments as disclosed herein;

FIG. 4 is a flow chart depicting an analytical process for retrieving relevant results with concepts as input to a concept selector, according to embodiments as disclosed herein;

FIG. 5 is a flow chart depicting an analytical process for retrieving relevant results with webpage as input to a concept selector, according to embodiments as disclosed herein;

FIG. 6 is a flow chart depicting the ranking process, according to embodiments as disclosed herein; and

FIG. 7 is a flow chart depicting a scenario where input is provided by a search engine to the concept selector.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Systems and methods for ranking retrieved terms, synonyms and concepts derived from various analytical processes by a concept selector are disclosed. Ranking methods rank the results obtained from the concept selector by employing semantic and contextual mapping techniques. Information may be input to the concept selector from various sources such as terms, concepts, web page contents, links to the web page and the like. The input information is analyzed by the concept selector. During the process of analysis, different synonyms may be extracted for the input terms from the domain specific thesaurus. For an input concept, the concept selector may compare the concept with the concepts stored in the concept relationship database to extract the most relevant concepts. In case a concept is not available in the concept relationship database, the concept selector may create concept maps and the created maps may be stored in the concept relationship databases for further references. In case of web page content provided as input to the concept selector, the concept selector employs a page analysis algorithm to derive the concept network for the web page. Further, page level concept network is analyzed for extracting the most relevant concept list. Extracted results which comprise of concepts, terms and the like are sent to the ranking module.

The ranking module employs a ranking algorithm for ranking the results. The ranking algorithm may rank the results obtained based on pre-defined filtering techniques such as semantic rules, business rules and so on. The ranked results may be output by the concept selector.

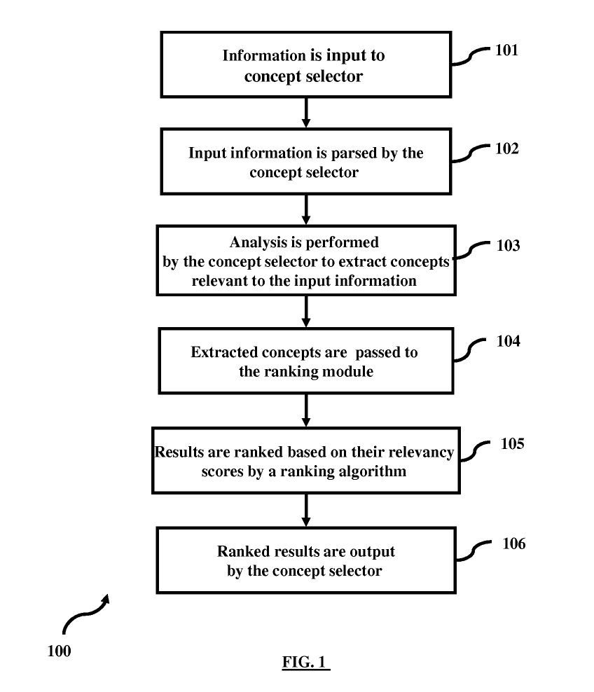

FIG. 1 is a flow chart depicting a process of extracting results for information input to a concept selector, according to embodiments as disclosed herein. The concept selector may be employed for retrieving required information and ranking the results extracted based on the relevancy of their scores. Information may be input (101) to the concept selector. Input information may be of the form such as terms, concepts, webpage contents and the like. The input information is parsed (102) by the concept selector for comparing the input information with the concept selector database content. Further, an analysis is performed (103) by the concept selector to extract related concepts for the input information. Depending on the type of input the required analysis is performed. In an example, input terms are mapped using the list of domain specific synonyms list to extract different synonyms for the terms. In addition, exactly matched and partially matched concepts to the input terms are also extracted.

When the input information is in the form of concepts, the concepts are mapped with concept relationship database to extract matched concepts. The concept relationship database is a database that stores information on how the concepts are semantically related to each other. The input concept is compared with the concept relationships database for extracting concepts, which are most relevant to the input concept. In cases wherein a particular concept is not available in the concept relationship database for comparison, concepts may be built and stored in the concept database for future references. Concept relationship database comprises of predefined maps that may be formed on analysis of the domain specific content to obtain most relevant factual and co-occurring concepts for the input data. Using factual information from sources and co-occurrence information, concept triples may be created and used for creating concept relationship maps, which are stored in the concept relationship database. The database contains set of named relations with weights assigned to concepts. This database also contains both machine acquired relationships and manually annotated relationships. This database also contains information on the terms that are used to denote a concept. There can be many terms associated with a single concept. In some embodiments, the extracted concepts and terms may be stored separately on different databases.

When webpage is provided as input, the concept selector performs a contextual analysis of webpage content to derive the concept network for the web page. Further, page level concept network is analyzed contextually for ranking relationships among the concepts to derive the most relevant concept list.

The extracted concepts are sent (104) to the ranking module. The ranking module employs (105) a ranking algorithm for ranking the final results based on the relevancy of their scores. The ranking module uses pre-defined business rules and semantic type prioritization to sort and rank the concepts extracted. The ranked results may be output (106) by the concept selector. The various actions in method 100 may be performed in the order presented, in a different order or simultaneously. Further, in some embodiments, some actions listed in FIG. 1 may be omitted.

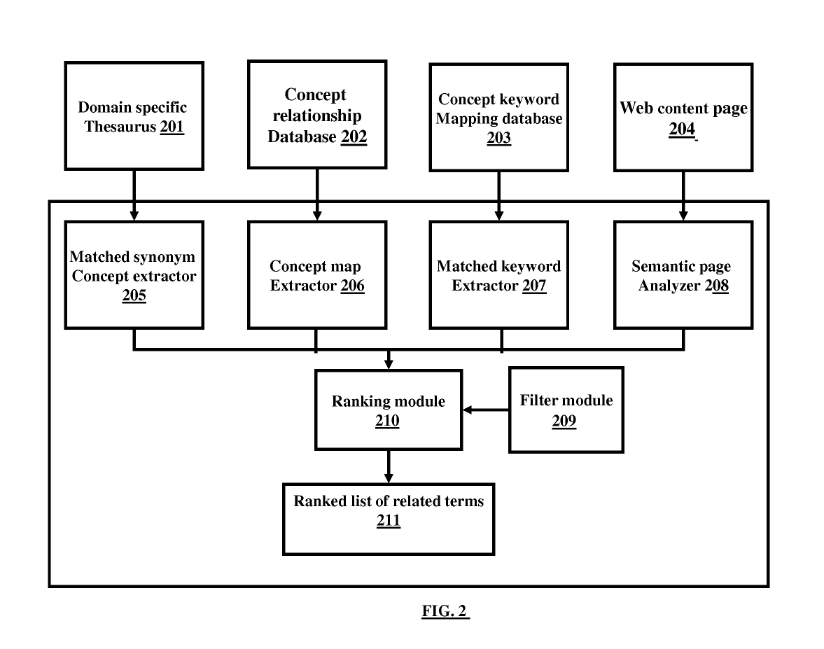

FIG. 2 illustrates a block diagram of a concept selector, according to embodiments as disclosed herein. The concept selector comprises a matched synonym concept extractor 205, concept map extractor 206, matched keyword extractor 207 and semantic page analyzer 208. In addition, a ranking module 210 and a filter module 209 exist for ranking the extracted results. Domain specific thesaurus 201 serves as input to the matched synonym concept extractor 205. Concept relationship database 202 is the input to concept map extractor 206, concept keyword mapping database 203 is the input to the matched keyword extractor 207 and web page content 204 is the input to the semantic page analyzer 208.

The domain specific thesaurus 201 includes thesaurus' terms for the information input to the concept selector. The thesaurus contains concepts with their terms and other related information for a number of domains. Domain specific thesaurus 201 uses semantic technology that is based on a thesaurus of concepts. Wherein each concept is provided with a unique identifier and one or more strings describing the concept. In general, there is a preferred term and 0 or more synonyms for a concept. In addition, each concept has been assigned one or more semantic types (STs). STs are a semantic description of the concept. Several STs also form a semantic group (SG) that can be viewed as a higher level organizational hierarchy. Each concept can also have 0 or more definitions. These definitions may describe one or more aspects of a concept. Also, there are descriptions for different end user knowledge levels. In an example, the descriptions provided to an expert in a field is different from that provided to a lay person. The technology can be generally applied on any domain as long as there is a thesaurus of that domain. The list of domain thesaurus obtained is input to a matched synonym concept extractor 205.

The matched synonym concept extractor 205 extracts different synonyms from the domain specific thesaurus. The terms in the input information are searched in the thesaurus. If there is a hit, all terms that describe the term are retrieved. The matching is of two types; one is exact match where the concepts are uniquely identified in the thesaurus and other is partial match where the obtained hits consist of all concepts that have the string representing the input query as part of a term of synonym. For example, if the input query is “migraine” it may result in the hits such as “common migraine” and “migraine with aura”. The output of the matched concept extractor 305 is list of concepts IDs and their terms and synonyms that have a partial match to the input information. Searches performed can be of two types: executed either in parallel or sequentially, based on configuration of the system.

The concept relationship database 202 is built by mining of a number of databases. A number of different relationships between concepts is established and stored in the concept relationship database 202. These relationships are of a pre-defined type. The database contains information on how the concepts are semantically related to each other. The database contains a set of named relations with weights assigned for every concept. The database contains both machine acquired relationships and manually annotated relationships. The database also contains information on which terms are used to denote a concept as there can be many terms (in different languages) associated with a single concept. In an example, there may be several relationship types (RTs) available for the biomedical/health and so on. There are at least three different relationship types:
1. Domain dependent relationships: these describe relationships between concepts that are typical to the domain;
2. Thesaurus based relationships: these are based on the hierarchical structure of the thesaurus, parent/child/sibling relationships can be derived and
3. Domain independent relationships: these are for instance, of the type RT of “co-occurrence” means that two concepts co-occur together in a specific unit (sentence, paragraph, text, page).
   The extracted concept is input to the concept map extractor 206.

The concept map extractor 206 is a database lookup in the concept relationship database for the input query which consists of one or more concept IDs. The output obtained for each queried concept ID is a list of relationships and concept IDs of related concepts to the input information.

The concept keyword mapping database 203 uses the concept as “a unit of thought”. The database employs terms as its way to describe information in the text or extracted from the text. In order to integrate the “unit of thought” concept with terms, a mapping algorithm that maps an input term to a number of concepts is formulated. This resulting list of concepts is rank ordered based on a vector matching score. The results of this process can be reversed in order to obtain a list of terms that map, or are relevant to a particular concept. The extracted data is input to the matched keyword extractor 207.

The matched keyword extractor 207 is a database lookup in the concept-term database for the input query. The output obtained is list of terms related to the input information.

The web content 204 includes content from a web page and submits the content to web service for analysis. The analysis may be done on the fly, which means that the page is immediately sent to the web service by the browser. Web content is input to the semantic page analyzer 208.

The semantic page analyzer 208 consists of an algorithm for performing web page analysis. Based on the textual content, a number of concepts may be selected that are highly relevant for the web page and informative for the topic that the page describes. The algorithm performs a concept and semantic relationship based analysis of the web page. The output of semantic page analyzer is a list of concept IDs related to both the input information provided and the complete content available on the webpage.

The filter module 209 contains the different filters and other rules to steer the ranking module 210. These filters may be both domain dependent and domain independent.

Ranking module 210 takes as input the different concept, terms, and applies different filtering techniques as supplied by the filter module to make a result set. The final result consists of a rank ordered list of terms, concepts, and synonyms among others. The exact format of IDs or terms is based on a configuration setting.

In an embodiment, all the extracted content may be cached at a server which can be retrieved and used at a later stage. In such a case the system may comprise of a web server, database server and a client server for implementing the code for the purpose of caching the required content.

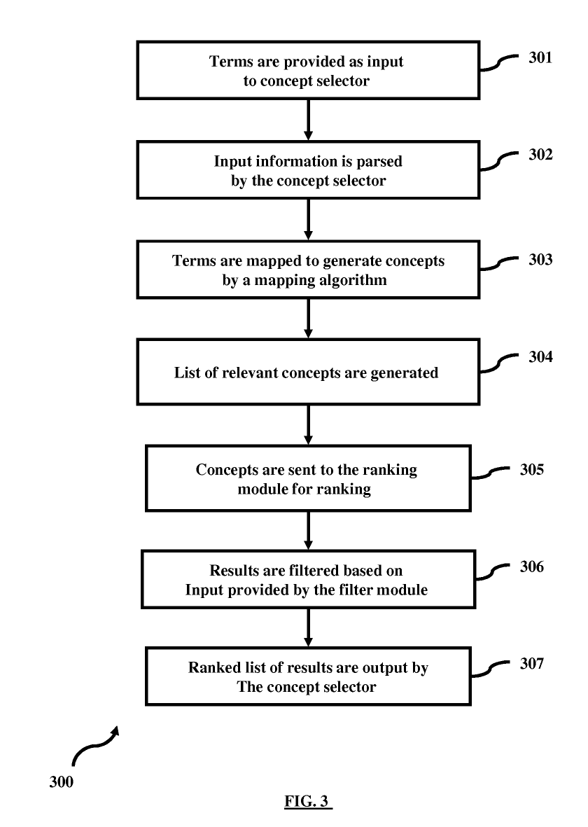

FIG. 3 is a flow chart depicting an analytic process for retrieving relevant results with terms as input to a concept selector, according to embodiments as disclosed herein. Consider the scenario wherein list of terms are provided (301) as input to the concept selector. The terms can include combinations of words, synonyms for the word and the like. The input terms are analyzed (302) by the concept selector. The terms may be mapped with the list of pre-defined terms in the concept keyword mapping database 203. The keyword mapping database 203 contains a list of terms for different domains. Keyword mapping database 203 is like a lookup for concept-keyword mapping. The database 203 employs a mapping algorithm for mapping the input terms with the list of terms stored in the database 203. The mapped list of terms may be extracted for generating (303) concept. Concepts are extracted from the mapping algorithm by mapping a particular term to a concept that is most relevant. Further, a list of most relevant concepts may be generated (304). In some embodiments, reverse mapping may also be done wherein when provided with concepts, the concepts can be mapped to obtain most relevant terms for the concept. The relevant list of concepts may be sent (305) to the ranking module 210 for ranking the final set of results. The ranking module 210 ranks the concepts based on inputs from the filter module 209. The filter module 209 employs (306) various semantic and business rules for filtering the results. The ranking module 210 employs a ranking algorithm for ranking. The ranking algorithm ranks the results based on the weights assigned to different concepts. Weights may be decided based on the relevance of the concepts to the input information. The Closer a concept, the higher is the weight assigned to that concept. The final list of ranked results may be then output (307) by the concept selector. The various actions in method 300 may be performed in the order presented, in a different order or simultaneously. Further, in some embodiments, some actions listed in FIG. 3 may be omitted.

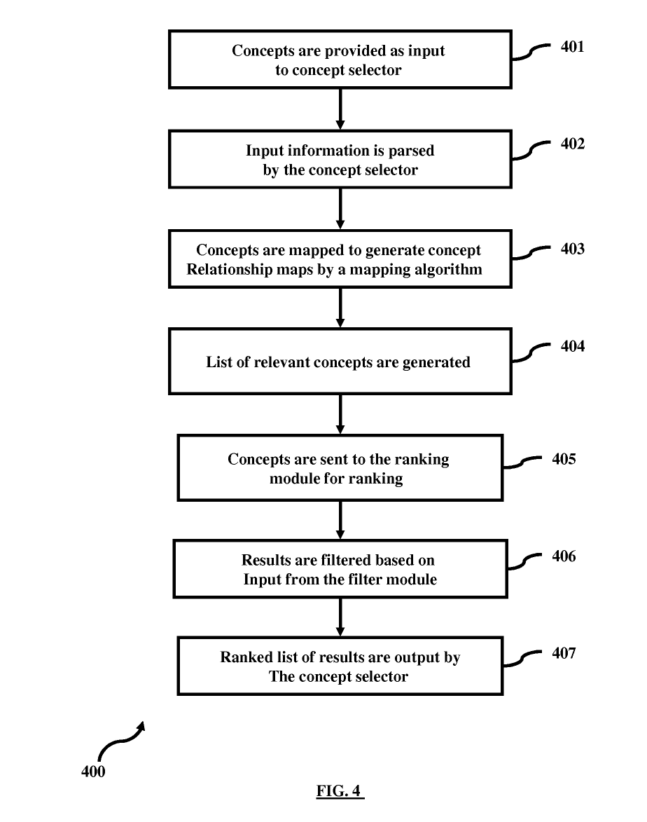

FIG. 4 is a flow chart depicting an analytical process for retrieving relevant results with concepts as input to a concept selector, according to embodiments as disclosed herein. The scenario herein deals with providing concepts as input to the concept selector. A set of concepts available may be input (401) to the concept selector. The input concepts are parsed (402) by the concept selector. The concepts may be mapped with a concept relationship database 202 to extract matched concepts. The concept relationship database 202 is built by mining a number of databases and provides relationships between different concepts. A number of relationships types may be available for a particular domain. The relationships types may be classified into three categories: 1. Domain dependent: These describe relationships between concepts that are typical in a particular domain. 2. Thesaurus: These are based on hierarchical structure of the thesaurus for example; parent/child/sibling relationships can be derived from this. 3. Domain independent: These include relationship types of co-occurrences i.e., two concepts co-occur together in a specific unit. The unit may be a paragraph, page text, sentence and so on. The mapping algorithm generates (403) a number of relationship types and concepts based on the information obtained from the database. Lists of relevant concepts are then generated (404). The relevant list of concepts may be sent (405) to the ranking module 210 for ranking the results. The ranking module 210 employs a ranking algorithm to rank the relevant concepts. The ranking module filters (406) the results based on the inputs obtained from the filter module 209. Results are filtered based on a set of pre-defined semantic rules and business rules. The ranked list of final results may then be output (407) by the concept selector. The various actions in method 400 may be performed in the order presented, in a different order or simultaneously. Further, in some embodiments, some actions listed in FIG. 4 may be omitted.

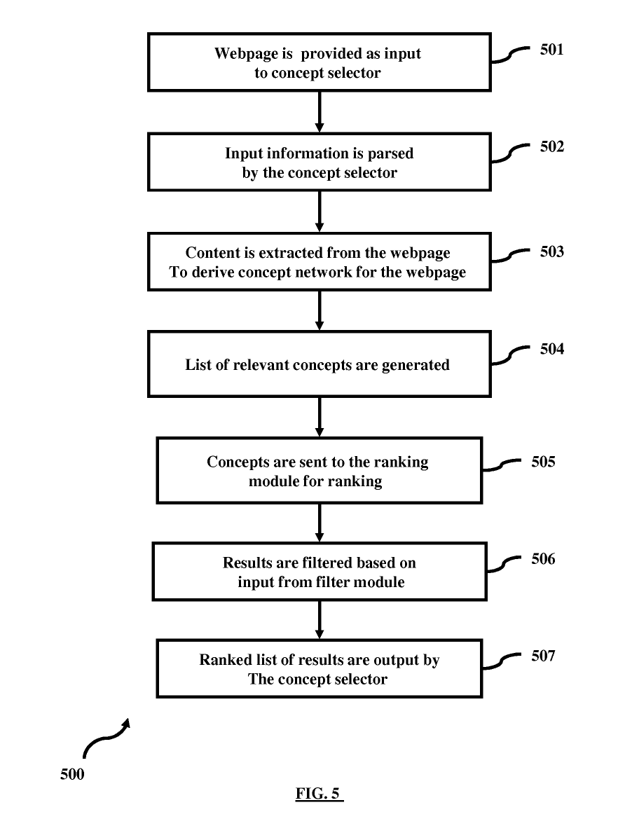

FIG. 5 is a flow chart depicting an analytical process for retrieving relevant results with webpage as input to a concept selector, according to embodiments as disclosed herein. A webpage or a link to webpage content is provided (501) as input to the concept selector. Input information is parsed (502) by the concept selector. The concept selector then sends parsed information from the webpage and submits the content to a web service for analysis. In a preferred embodiment, this is done on the fly i.e., the webpage is sent to the web browser immediately for analysis. In an embodiment, for performance reasons infrastructure for caching data may be employed. The extracted webpage content is sent to a semantic webpage analyzer 208. Contextual and semantic analysis of the webpage is performed by the semantic webpage analyzer 208 to derive (503) concept network for the webpage. The list of relevant concepts is generated (504) for the webpage. The relevant concepts are sent (505) to the ranking module 210 for ranking the concepts. The ranking module 210 employs a ranking algorithm to rank the relevant concepts. The ranking module filters (506) the results based on the inputs obtained from the filter module 209. Results are filtered based on a set of pre-defined semantic rules and business rules. The ranked list of final results may then be output (507) by the concept selector. The various actions in method 500 may be performed in the order presented, in a different order or simultaneously. Further, in some embodiments, some actions listed in FIG. 5 may be omitted.

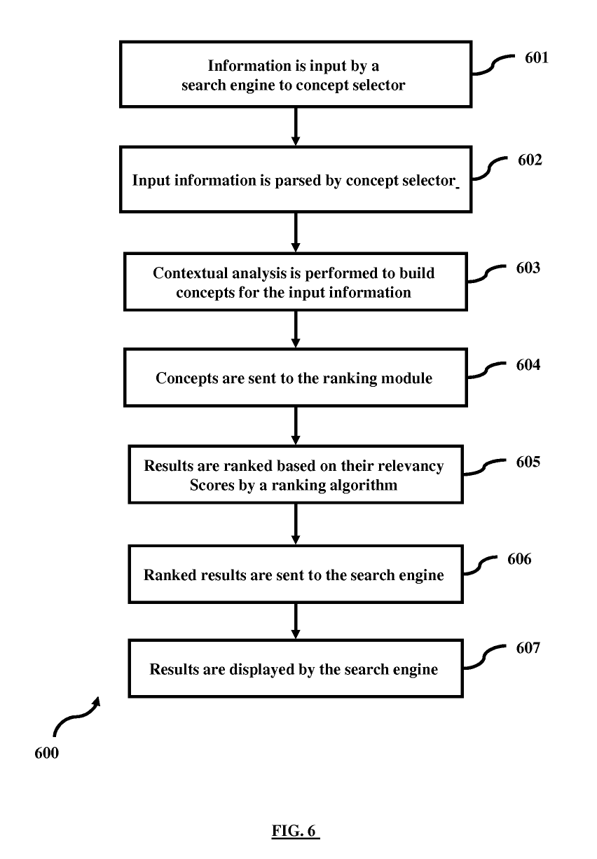

FIG. 6 is a flow chart depicting a scenario where input is provided by a search engine to the concept selector, according to embodiments as disclosed herein. The embodiment herein is an illustration of an application of the concept selector and does not aim to limit the scope of the application. Consider a case wherein a user would like to search information on the Internet by employing a search engine. User may want to look for online advertisements on the Internet related to a search query input by him. In an example, user may want information on online advertisement related to ‘migraine’. The user then inputs a query for ‘migraine’. The user may input his query in any of the commonly employed search engines on the Internet such as GOOGLE search engine, YAHOO search engine and so on. The query may include some terms, combinations of terms, contents from webpage, concepts and so on. The search engine sends (601) the input information from the user to the concept selector. The input information is parsed (602) by the concept selector. Contextual analysis of the input information is performed (603). During analysis, a list of synonyms relevant to the input terms is extracted from the domain specific thesaurus 201. The domain specific thesaurus 201 is built on thesaurus of concepts. During the mapping, if there is a hit for a particular term, all the terms describing the term are extracted. The matches could be either an exact match for the term or a partial match. In the considered example, if the input word is “migraine” then exact matches for the term such as ‘migraine’ and partial matches such as ‘common migraine’ and ‘migraine with aura’ are extracted from the domain specific synonym. In case if the input information contains concepts, the concepts may be mapped with the concept relationship database to extract most relevant concepts. If the input contains webpage content, the content is analyzed by the semantic webpage analyzer to build concept network for the webpage.

Once the results from different analytical processes are extracted, the results are sent (604) to the ranking module 210. The ranking module 210 employs a ranking algorithm to rank the relevant concepts. The ranking module filters (605) the results based on the inputs obtained from the filter module 209. Results are filtered based on a set of pre-defined semantic rules and business rules. The ranked list of final results may then be sent (606) to the search engine. The search engine displays (607) the ranked results to the user. The various actions in method 600 may be performed in the order presented, in a different order or simultaneously. Further, in some embodiments, some actions listed in FIG. 6 may be omitted.

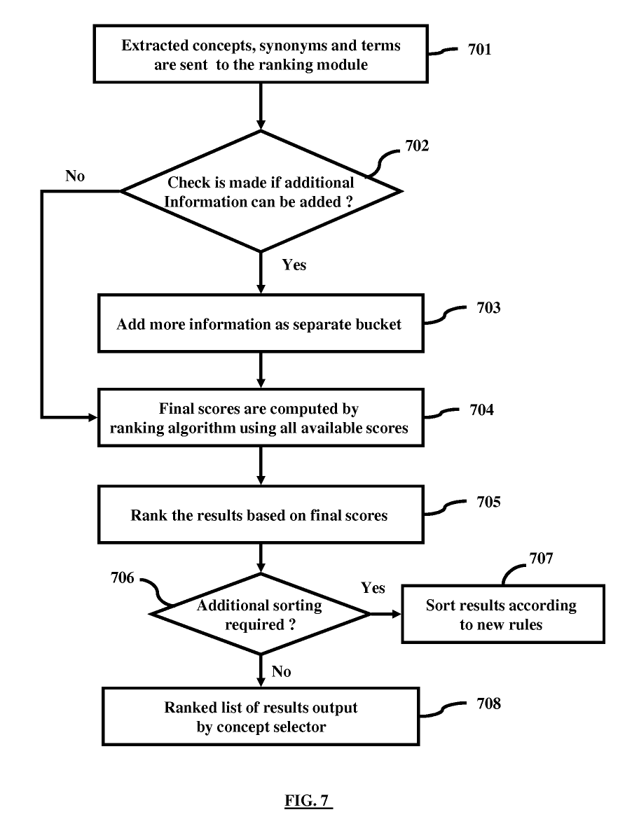

FIG. 7 is a flow chart depicting the ranking process, according to embodiments as disclosed herein. The concept selector employs a ranking module 210 for ranking the results based on their relevancy scores. The extracted results from different analytical processes, which comprises of synonyms, concepts and terms are sent (701) to the ranking module 210 for ranking. The ranking module 210 employs a ranking algorithm and applies filter techniques provided by the filter module 209 to provide a final result set. A check is made (702) if any additional information may be added as a separate ‘component’ for filtering the results. In case additional rules need to be added to the filtering techniques, the rules are added (703) in the form of a separate ‘component’. On the other hand, if no more rules need to be added the process goes to step 704. The ranking algorithm computes (704) the final scores for all the terms, concepts and synonyms using all the available ranking scores. The results are ranked (705) based on their scores where the highest score represents the best final result. Further, a check is made (706) with the filter module 209 if any additional sorting or weighting needs to be done. In case additional sorting is required, the results are sorted (707) according to the new rules. If additional sorting is not required, the ranked final results are output (708) by the concept selector.

In an example, consider the results obtained from the analytical process is ranked and presented to the ranking module in the following manner.

| CID | Term | Rank |
|---|---|---|
| C0000003 | My term Aa | 1 |
| C0000003 | My term Aa plus | 2 |
| C0001234 | Another term | 3 |

CID represents a concept ID. Depending on the final result set obtained, either the concept ID and rank, or the term and the rank may be employed by the ranking algorithm for ranking the results. Since analytical processes for extracting synonyms, concepts and terms are employed in different applications; their attribution to the final result set can be weighted. Weights for the analytical processes are assigned as vectors say ‘wₙ’. In an example, considering the case where there are four analytic components, then n=4 and w=(w1, w2, w3, w4) in the vector ‘wₙ’. The final score in the domain [0, 1] (where 1 represents most relevant term) is computed by using the equation:

$${s}_{t} = \frac{{\sum }_{i = 1}^{n} {c}_{i}}{{\sum }_{i = 1}^{n} {w}_{i}}$$

Wherein co-efficient cᵢ is given as

$${c}_{i} = \{ \begin{matrix}1 / {r}_{i} if {r}_{i} > 0 \\ 0 if {r}_{i} = 0 ,\end{matrix}$$

where rᵢ represents the rank of the i^{th} element according to the analytic process. The score represents the new rank value for the concepts in view of the filter rules.

In an embodiment for web based advertising application, the cost per click (CPC) information for each term can also be included as a separate element with its own weight. In such case, n is equal to 5.

The embodiments disclosed herein can be implemented through at least one software program running on at least one hardware device and performing network management functions to control the network elements. The elements shown in FIG. 2 include blocks which can be at least one of a hardware device, or a combination of hardware device and software module.

The embodiment disclosed herein describes a method for ranking results derived from various analytical processes by a concept selector. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in a programming language, or implemented by one or several software modules being executed on at least one hardware device. The hardware device can be any kind of portable device that can be programmed. The method embodiments described herein could be implemented partly in hardware and partly in software. Alternatively, the invention may be implemented on different hardware devices, e.g. using a plurality of CPUs.

What is claimed is:

1. A method of selecting relevant concepts using a concept selector, a domain specific thesaurus, a concept relationship database, a concept keyword mapping database, the method comprising:
accepting an input by the concept selector;
identifying concepts relevant to the input; and
extracting relevant concepts based on concept relationships using the identified concepts by the concept selector.

2. The method of claim 1, wherein the input is one among terms, keywords, concepts, content, and links to content.

3. The method of claim 1, wherein when the input is set of terms, identifying concepts comprises identifying concepts relevant to the set of terms using a keyword concept mapping database.

4. The method of claim 1, wherein when the input is content, identifying concepts comprises:
performing semantic analysis on the content;
deriving concept network from the content; and
obtaining relevant concepts from the concept network.

5. The method of claim 1, wherein when the input is link to content, identifying concepts comprises:
obtaining content using the link;
performing semantic analysis on the content;
deriving concept network from the content; and
obtaining relevant concepts from the concept network.

6. The method of claim 1, wherein extracting relevant concepts comprises mapping identified concepts from the input to obtain a list of relevant concepts from the concept relationship database.

7. The method of claim 6, wherein when there are no mapped concepts in the concept relationship database relating to the identified concepts for the input, the method further comprises adding new concept relationship in the concept relationship database for future use.

8. The method of claim 1, the method further comprising ranking the extracted concepts by a ranking module using a plurality of weights, wherein ranking comprises:
obtaining the relevant concepts and their relevancy ranking according to semantic and concept relationships;
obtaining a ranking score for the relevant concepts using a plurality of weights based on filtering rules, according to
$${s}_{t} = \frac{{\sum }_{i = 1}^{n} {c}_{i}}{{\sum }_{i = 1}^{n} {w}_{i}}$$
where co-efficient cᵢ is given by
$${c}_{i} = \{ \begin{matrix}1 / {r}_{i} if {r}_{i} > 0 \\ 0 if {r}_{i} = 0 ,\end{matrix}$$
wᵢ is the weight for i^{th} element, and rᵢ represents rank of the i^{th} element according to semantic and concept relationships; and
ranking the relevant concepts using the score obtained.

9. The method of claim 8, the method further comprising:
checking if any additional rules are to be added during filtering; and
adding additional rules before obtaining ranking.

10. A method of ranking search engine results using a concept selector, a domain specific thesaurus, a concept relationship database, a concept keyword mapping database, the method comprising:
accepting a set of one or more terms by the concept selector;
analyzing the input by the concept selector;
identifying concepts relevant to the analyzed input;
extracting relevant concepts based on concept relationships based on identified concepts by the concept selector;
ranking the relevant concepts using a plurality of weights based on filtering rules; and
ranking search results using ranking information of the relevant concepts by the search engine.

11. A method of selecting relevant keywords to be used for providing advertisements, the method comprising:
accepting a web page for analysis;
performing semantic analysis on content of the web page;
deriving concept network for the content of the web page;
identifying concepts relevant to the web page;
extracting relevant concepts based on concept relationships based on identified concepts by the concept selector;
ranking the relevant concepts using a plurality of weights based on filtering rules; and
obtaining keywords relating to the relevant concepts based on the ranking from a concept keyword relationship mapping database.

12. A system for selecting relevant concepts, the system comprising at least one means for:
accepting an input;
identifying concepts relevant to the input; and
extracting relevant concepts based on concept relationships using the identified concepts.

13. The system of claim 12, wherein the input is one among terms, keywords, concepts, content, and links to content.

14. A system for ranking search engine results, the system comprising at least one means for:
accepting a set of one or more terms;
identifying concepts relevant to the input;
extracting relevant concepts based on concept relationships based on identified concepts;
ranking the relevant concepts using a plurality of weights based on filtering rules; and
ranking search results using ranking information of the relevant concepts by the search engine.

15. A system for selecting relevant keywords to be used for providing advertisements, the system comprising at least one means for:
accepting a web page for analysis;
performing semantic analysis on content of the web page;
deriving concept network for the content of the web page;
identifying concepts relevant to the web page;
extracting relevant concepts based on concept relationships based on identified concepts by the concept selector;
ranking the relevant concepts using a plurality of weights based on filtering rules; and
obtaining keywords relating to the relevant concepts based on the ranking from a concept keyword relationship mapping database.
